(19) United States
(12) Patent Application Publication
(10) Pub. No.: US 2006/0237586 A1
(43) Pub. Date: Oct. 26, 2006

(54) ADJUSTABLE ATTENUATION SYSTEM FOR A SPACE RE-ENTRY VEHICLE SEAT

(75) Inventors: Victor J. Barackman, Chula Vista, CA (US); Xavier D. Simon, Huntington Beach, CA (US)

Correspondence Address: OSTRAGER CHONG FLAHERTY & BROLTMAN, P.C., 250 PARK AVENUE, SUITE 825, NEW YORK, NY, 10177-0899, US

(73) Assignee: THE BOEING COMPANY, Chicago, IL (US)

(21) Appl. No.: 10/907,931

(22) Filed: Apr. 21, 2005

(51) Int. Cl. B64D 11/06

(52) U.S. Cl. 244/118.6

(57) ABSTRACT

An adjustable attenuation system 10 for a space re-entry vehicle seat having a frame 12 that supports at least one seat 14 mounted to and supported on the frame 12 at the seat back. A plurality of struts 16 is attached to the frame 12 in predetermined locations 18. The struts 16 are also attached, by way of mounting brackets 20 to predetermined locations on the spacecraft (not shown). The struts 16 are interconnected by a tubing system 22, which sets the tension of the struts 16 by way of a controller 24.

### GOVERNMENT CONTRACT

The invention described herein was made in the performance of work under NASA Contract No. NAS8-01099 and is subject to the provisions of Section 305 of the National Aeronautics and Space Act of 1958 (72 Stat.435:42 U.S.C.2457.)

### TECHNICAL FIELD

The present invention relates generally to seating for the crew of an aircraft or spacecraft and more particularly to an adjustable attenuation frame for a seating system.

### BACKGROUND ART

Advancements in space travel have made manned space flights more realistic for a larger variety of people. In the past, space missions had crewmember sizes that were much more generic. For example, in the past the crew size was always three and the astronauts were all of relatively the same size and weight. The attenuation system in a space re-entry vehicle was not designed to deal with large differences in weight. In the space shuttle, there are individual seats and attenuation is mitigated with landing gear struts. However, there is a need for an attenuation system for a space re-entry vehicle that is capable of providing the same level of protection for a much wider variety of crewmembers and sizes.

In space travel today and as it is expected to change in the future, crewmembers are becoming more varied and people of many shapes and sizes need to be accommodated. Crew seats need to conform to crew sizes ranging from the smallest possible, for example a 5^{th} percentile Japanese female in shirt sleeves, to the largest possible, such as a 95^{th} percentile American male in an inflated space suit.

Crewmember comfort is of course a concern. But more importantly, the support and safety of the crewmembers throughout take-off, flight, and landing are the most critical of concerns. Support of the crewmember in the seat during take-off, flight, and landing are a critical concern for manned space travel, especially when commercial space travel is on the brink of becoming more mainstream. Crewmember support is especially important during launch, re-entry and landing phases of the flight when the forces on crewmembers are the greatest.

An attenuation system is used to absorb forces that the space re-entry vehicle crew seats are subject to during take-off, re-entry and landing. However, in the past, attenuation frames have a fixed tension setting for a known crew size and the tension is not adjustable to accommodate any variations. That is the system is capable of absorbing shock for a predetermined, or fixed, weight of the crewmembers.

### SUMMARY OF THE INVENTION

Seat design for manned space travel has become more important as the shapes and sizes of crewmembers become more varied. Members of a crew can range in size from a single, fifth percentile Japanese female to four ninety-fifth percentile American males. Therefore, an attenuation system must be capable of handling weights ranging from about 100 pounds to 1000 pounds and result in no personal injuries to any crewmember upon a hard landing. The adjustable attenuation system provides the same level of protection for a single small crewmember as for a full crew of four large crewmembers.

A bench seating system capable of carrying one or more crewmembers of varying size and shape is provided. The bench seating system has an attenuation system that is adjustable to accommodate a large range of crewmembers and crewmember sizes. The tension in the attenuation system is adjustable at any time prior to take-off and during a flight mission, to accommodate a range of crewmembers from one small crewmember to four large crewmembers.

The attenuation system is comprised of a system of struts, either hydraulic or pneumatic, attached to a frame that supports the bench seat and the tension in the struts is adjusted either manually, or automatically to accommodate the crew. A first setting is made prior to launch of the spacecraft depending on the parameters of the crewmembers, and the setting can be changed as desired during the mission, should the parameters of the crewmembers change for return in that vehicle.

Additional advantages and features of the present invention will become apparent from the description that follows, and may be realized by means of the instrumentalities and combinations particularly pointed out in the appended claims, taken in conjunction with the accompanying drawings.

### BRIEF DESCRIPTION OF THE DRAWINGS

In order that the invention may be well understood, there will now be described some embodiments thereof, given by way of example, reference being made to the accompanying drawings, in which:

FIG. 1 is a perspective view of the bench seat and adjustable attenuation frame of the present invention.

FIG. 2 is a side view of the bench seat and adjustable attenuation system of the present invention.

FIG. 3 is a rear perspective view of the bench seat and adjustable attenuation system of the present invention.

### BEST MODE FOR CARRYING OUT THE INVENTION

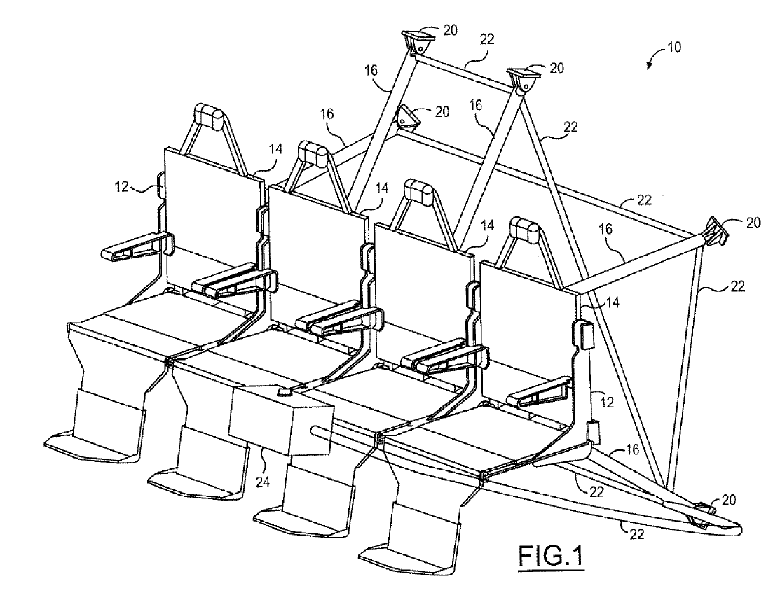

FIG. 1 is a perspective view of the adjustable attenuation system 10. A frame 12 supports at least one seat 14. A crew usually consists of more than one member, so for example purpose, four seats 14 are shown in FIG. 1. The seats 14 are mounted to the frame 12 and are supported on the frame 12 at the seat back. A plurality of struts 16 are attached to the frame 12 in predetermined locations 18. The struts 16 are also attached, by way of mounting brackets 20 to predetermined locations on the spacecraft (not shown). The struts 16 are interconnected by a tubing system 22. The tubing system 22 sets the tension of the struts 16 by way of a control 24.

The at least one seat 14 is shown in FIG. 1 as a crew couch, or bench seating system. Crewmember sizes and crewmember quantity can vary considerably. Space availability is a primary concern on board a spacecraft, and therefore, a bench seat system is a good solution. The bench seat 14 shown in FIG. 1 can accommodate from one to four crewmembers, but a similar system can be designed to accommodate any number of crew.

The attenuation system 10 is set to a predetermined tension using the control 24. The control sends the right amount of fluid, either oil for a hydraulic system, or air for a pneumatic system, through the tubing system 22 to the plurality of struts 16.

It is desirable to have as few struts 16 as possible in order to minimize the weight carried by the spacecraft. The number of struts 16 shown in FIG. 1 is for example purposes only. It should be noted that it may be necessary to increase or decrease the number of struts in the system depending on the spacecraft and its particular mission purpose.

As discussed above, the adjustability of the attenuation system can be controlled by a hydraulic, pneumatic, or electrical system. The control 24 can be either a manual dial setting, or it may be automated, for example controlled by a computer system (not shown). Prior to launching the spacecraft, the ground crew makes an initial adjustment to the attenuation system. The adjustment setting depends on the number of crewmembers and their weight range. This initial setting need not be changed unless a different crew is returning in the re-entry vehicle.

In one embodiment, the crew can easily make adjustments by selecting from one of a plurality of predetermined pre-set ranges prior to descent. For example, the pre-set ranges may be set to one of six selections. A first setting is for a single, small crewmember weighing from ninety to one hundred twenty five pounds. A second setting is for one large and one medium, or two small crewmembers whose combined weight totals one hundred twenty five to two hundred fifty pounds. A third setting is for two large crewmembers, one large and one medium crewmember, or one large and one small crewmember whose combined weight totals from two hundred fifty pounds to four hundred fifty pounds. A fourth setting is for various combinations of large, medium and small crewmembers whose combined weight totals from four hundred fifty to six hundred fifty pounds. A fifth setting is for various combinations of large, medium and small crewmembers whose combined weight totals from six hundred fifty to eight hundred fifty pounds. A sixth setting is for four large crewmembers whose combined weight totals from eight hundred fifty pound to one thousand pounds.

The attenuation system 10 is capable of handling weight ranging from ninety pounds to one thousand pounds and adjusts to protect any combination of crewmembers adequately without personal injuries upon a hard landing.

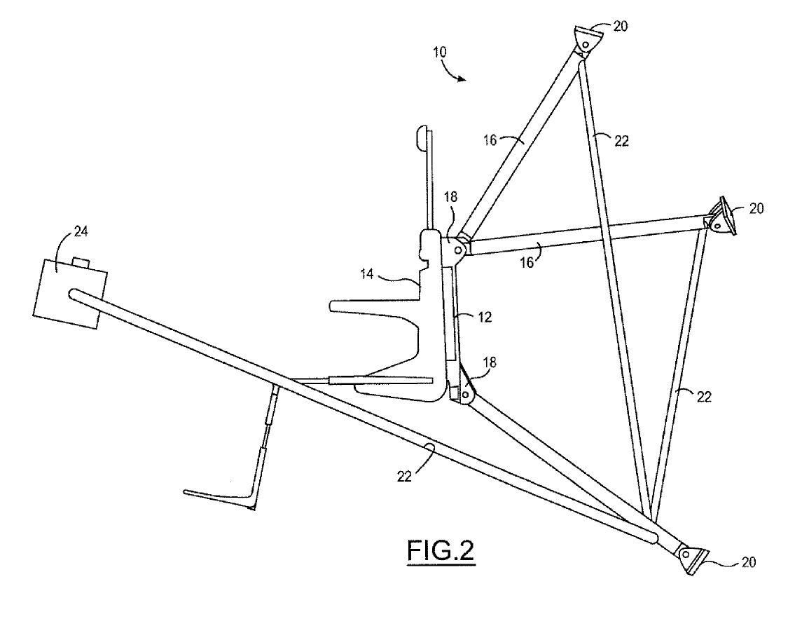

FIG. 2 is a side view of the attenuation system 10. It is clear from the side view that the frame 12 supports the seats 14 and the frame 12 is attached to the spacecraft (not shown) by way of the mounting brackets 20. The seats 14 are suspended from the frame 12. Therefore, the shock of an impact from a hard landing is absorbed by the struts 16 and frame 12 and the seats 14 are free to move and avoid injuring the crew. The tubing system 22 moves freely with the movement of the struts 16. The pivotal engagement of the struts 16 to the mounting brackets 20 and the frame 12 at predetermined locations 18 is also shown clearly in FIG. 2.

The seat 14 is suspended from the attenuation system 10 by the frame 12 and it is considered to be floating, or able to move freely in response to movement of the struts 16. The struts absorb the shock of an impact and based on the tension setting at the control 24, the seat 14 will move accordingly and avoid any direct impact to the crewmembers.

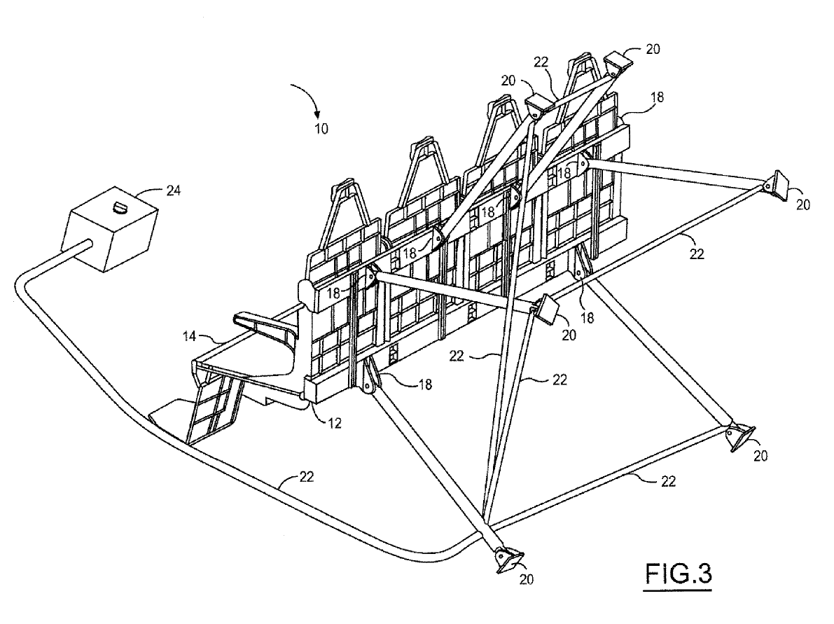

FIG. 3 is a perspective view from the rear of the attenuation system 10. The attachment locations 18 of the struts 16 to the frame 12 can be seen at several locations across the frame. The struts 16 are pivotally engaged to the frame 12 at the attachment locations 18. The struts 16 are attached to the spacecraft, by way of the mounting brackets 20, and also have a pivotal engagement thereto. In an ideal arrangement, struts 16 are mounted to the upper, side and bottom of the spacecraft. However, it should be noted that it may be required to attach either more or fewer struts to various locations depending on the space vehicle itself, as well as other considerations such as the mission's purpose.

The pivotal engagement allows the attenuation system 10 to move as necessary and absorb the impact of a hard landing. The suspended bench seat 14 can move vertically and avoids any of the impact directly. Therefore, the crewmembers are well protected from injury. The tension setting of the attenuation system 10 will be adjusted depending on the weight of the crew.

The frame 12, as shown in FIGS. 1 through 3, provides support for the bench crew seats 14. It also provides the attachment points 18 for the struts. The frame size and weight should be kept to a minimum. However, the strength and the integrity of the frame should not be compromised as it could affect the safety and support of the crewmembers.

The struts 16 will vary in size and number as necessary for the vehicle the attenuation system is being designed for. The six struts 16 shown in FIG. 3 is one example of many possible configurations. The struts 16 are spaced throughout the length and width of the frame 12. The number and size of the struts 16 should be maximized to the limit the design will allow. As always, in space travel, size and weight considerations are very important and will factor into the strut system design.

The tubing system 22 interconnects the struts 16 and feeds the air or fluid necessary to adjust the tension in the struts 16. In the embodiment shown in FIGS. 1 through 3, each and every strut is fed by the tubing system. The tubes interconnect all of the struts. This would be the ideal arrangement to maximize the range of adjustability for the attenuation system. It is possible however, that less than all of the struts are adjustable, but it is necessary that at least one strut 16 have adjustable tension. This would reduce the size and weight of the attenuation system depending on the design requirements for a specific application. In one embodiment, at least one strut is fed by the tubing system, and the other struts would have a fixed tension. The tubing system 22 should be comprised of flexible tubing that can withstand any movement of the seats 14 and struts 16 upon impact.

The control 24 is used to set and adjust the tension in the struts 16 by way of the tubing system 22. The control 24 can be adjusted manually, as by a dial turned to a specific setting by the ground crew, or the crewmembers of the mission. It is also possible that the control 24 is automated and is set and adjusted by computer control.

From the foregoing, it can be seen that there has been brought to the art a new and improved attenuation system for seating in a re-entry space vehicle. It is to be understood that the preceding description of the preferred embodiment is merely illustrative of some of the many specific embodiments that represent applications of the principles of the present invention. Clearly, numerous and other arrangements would be evident to those skilled in the art without departing from the scope of the invention as defined by the following claims.

What is claimed is:

1. An adjustable attenuation system for a space re-entry vehicle seat comprising:
at least one seat;
a frame for suspending the at least one seat, the frame having a plurality of attachment points;
a plurality of struts having first and second ends, a first end of each strut being pivotally engaged to the plurality of attachment points of the frame, at least one strut of the plurality of struts having adjustable tension;
means for adjusting the tension in the at least one strut; and
a plurality of mounting brackets for attaching the second end of each of the plurality of struts in pivotal engagement to the space re-entry vehicle.

2. The system as claimed in claim 1 wherein the means for adjusting the tension in the at least one strut further comprises:
a control system for controlling a tension setting for the at least one adjustable tension strut;
a tubing system for connecting the control system to the at least one adjustable tension strut.

3. The system as claimed in claim 1 wherein the plurality of struts further comprises pneumatic struts.

4. The system as claimed in claim 1 wherein the plurality of struts further comprises hydraulic struts.

5. The system as claimed in claim 2 wherein the control further comprises a manual control for setting the tension in the at least one strut.

6. The system as claimed in claim 2 wherein the control further comprises an automatic control for setting the tension in the at least one strut.

7. The system as claimed in claim 1 wherein the tubing system further comprises flexible tubing to accommodate movement in the plurality of struts while maintaining connection of the tubing to the struts.

8. The system as claimed in claim 7 wherein the tubing system further comprises a plurality of flexible tubes interconnecting the plurality of struts.

9. An adjustable attenuation system for a seat in a vehicle, the attenuation system comprising:
a bench seat member;
a frame member having a front side with the bench seat member attached thereto and a rear side having a plurality of brackets spaced across the frame;
a plurality of struts, each strut having a first end attached to one of the plurality of brackets on the frame and a second end having a mounting bracket pivotally engaged thereto, the mounting bracket being affixed to any non-moving surface inside the vehicle, the struts having a tension that is adjustable;
a network of tubes attached to and interconnecting with the plurality of struts and transporting a fluid for adjusting the tension of the struts;
a controller for setting a desired tension of the struts, the controller attached to the network of tubes; and
wherein the tension of the struts is set by the controller, communicated to the struts by way of the network of tubes and adjusted at the strut to absorb an impact, the frame member and bench seat member are suspended from the plurality of struts so that the bench seat member is free to move with movement of the plurality of struts.

10. The adjustable attenuation system claimed in claim 9 wherein the bench seat further comprises seating space for a plurality of passengers.

11. The adjustable attenuation system as claimed in claim 9 further comprising:
the controller having manual control of the tension in the plurality of struts; and
the plurality of struts being pneumatic struts.

12. The adjustable attenuation system as claimed in claim 9 further comprising:
the controller having manual control of the tension in the plurality of struts; and
the plurality of struts being hydraulic struts.

13. The adjustable attenuation system as claimed in claim 9 further comprising:
the controller having automatic control of the tension in the plurality of struts; and
the plurality of struts being electronic struts.

14. The adjustable attenuation system as claimed in claim 10 further comprising a plurality of pre-set tension settings corresponding to a total weight of the passengers.

15. The adjustable attenuation system as claimed in claim 10 wherein the plurality of pre-set tension settings further comprises:
a plurality of weight ranges that correspond to each of the plurality of pre-set tension settings;
each pre-set tension setting having an incremented predetermined resistance for the attenuation system that corresponds to each of the plurality of weight ranges; and
wherein a pre-set tension setting for a lighter weight range has a lower predetermined resistance and a pre-set tension setting for a heavier weight range has a higher predetermined resistance.

16. The adjustable attenuation system as claimed in claim 9 wherein the network of tubes further comprises flexible tubes attached to each strut in the plurality of struts.

17. A seating system for a space re-entry vehicle comprising:
a bench seat have predetermined attachment points;
an adjustable attenuation frame pivotally engaged to the bench seat at said predetermined attachment points and the adjustable attenuation system pivotally engaged to predetermined locations inside the space re-entry vehicle whereby the bench seat is suspended from the adjustable attenuation frame and the space re-entry vehicle;
a controller in communication with the adjustable attenuation frame, the controller for controlling the tension of the adjustable attenuation frame.

18. The seating system as claimed in claim 17 further comprising:
a plurality of predetermined tension settings stored in the controller, the predetermined tension settings based on a weight of the bench seat and at least one crewmember seated in the bench seat; and
a network of flexible tubing in communication with the controller and the adjustable attenuation frame, the network of flexible tubing for communicating one of the plurality of predetermined tension settings from the controller to the adjustable attenuation frame.

19. The seating system as claimed in claim 18 wherein the controller further comprises manual control of the plurality of predetermined tension settings.

20. The seating system as claimed in claim 18 wherein the controller further comprises automatic control of the plurality of predetermined tension settings.
